(19) United States
(12) Patent Application Publication
(10) Pub. No.: US 2006/0061521 A1
(43) Pub. Date: Mar. 23, 2006

(54) Method and apparatus of driving plasma display panel

(75) Inventor: Yong-Jin Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/221,896

(22) Filed: Sep. 9, 2005

(30) Foreign Application Priority Data
Sep. 23, 2004 (KR) 10-2004-0076328

(51) Int. Cl. G09G 3/28

(52) U.S. Cl. 345/60

(57) ABSTRACT

A driving method for a plasma display panel in which gray-scale levels are represented by a combination of sub-fields. The method includes, during a reset period of a first sub-field, applying a rising ramp pulse and a falling ramp pulse to a first electrode, thus initializing wall charges of a discharge cell, wherein a self-erase discharge is generated if a strong discharge occurs between the first electrode and a second electrode, and during a reset period of a second sub-field, applying a falling ramp pulse to the first electrode.

### CROSS-REFERENCE TO RELATED PATENT APPLICATION

This application claims priority to and the benefit of Korean Patent Application No. 10-2004-0076328, filed on Sep. 23, 2004, which is hereby incorporated by reference for all purposes as if fully set forth herein.

### BACKGROUND OF THE INVENTION

1. Field of the Invention

The present invention relates to a driving method of a plasma display panel (PDP), and more particularly, to a PDP driving method for initializing wall charges even when a strong discharge unintentionally occurs during a reset period.

2. Discussion of the Background

FIG. 1 shows an electrode arrangement of a plasma display panel (PDP).

Referring to FIG. 1, scan electrode lines Y₁, Y₂, . . . , Yₙ and common electrode lines X₁, X₂, . . . , Xₙ (these electrode lines may be referred to as ‘sustain electrode lines’) are arranged in parallel on the PDP. Address electrode lines A₁, A₂, . . . , Aₘ are arranged to orthogonally intersect the scan electrode lines Y₁, Y₂, . . . , Yₙ and the common electrode lines X₁, X₂, . . . , Xₙ.

Discharge cells Ce are demarcated and formed by partition walls at intersections of the scan electrode lines Y₁, Y₂, . . . , Yₙ, the common electrode lines X₁, X₂, . . . , Xₙ, and the address electrode lines A₁, A₂, . . . , Aₘ. Each discharge cell Ce acts as a pixel of the PDP. A red (R), green (G) or blue (B) phosphor and plasma forming gas are filled inside the discharge cells Ce, and wall charges are formed inside a discharge cell Ce by applying voltages to the corresponding scan, common, and address electrodes. Plasma is generated from the plasma forming gas by the wall charges, and the phosphor in the discharge cell Ce is excited by ultraviolet radiation caused by the plasma, thereby emitting light.

Hereinafter, the scan electrode lines Y₁, Y₂, . . . , Yₙ are referred to as Y electrode lines, and common electrode lines X₁, X₂, . . . , Xₙ are referred to as X electrode lines.

U.S. Pat. No. 5,541,618 discloses a widely used address-display separation (ADS) driving method. FIG. 2 is a view for explaining a conventional ADS driving method for driving a PDP's Y electrode lines.

Referring to FIG. 2, a unit frame may be divided into a predetermined number of sub-fields, for example, 8 sub-fields SF1, . . . , SF8, in order to implement time division gray-scale display. Also, the sub-fields SF1, . . . , SF8 may be divided into reset periods (not shown), address periods A1, . . . , A8, and sustain-discharge periods S1, . . . , S8, respectively.

During the address periods A1, . . . , A8, a display data signal is applied to the address electrode lines (A₁, A₂, . . . , Aₘ of FIG. 1), and simultaneously, corresponding scanning pulses are sequentially applied to the Y electrode lines Y₁, Y₂, . . . , Yₙ.

During the sustain-discharge periods S1, . . . , S8, a sustain discharge pulse is alternately applied to the Y electrode lines Y₁, Y₂, . . . , Yₙ and X electrode lines X₁, X₂, . . . , Xₙ so that a sustain discharge occurs in discharge cells in which wall charges were formed during the previous address periods A1, . . . , A8.

A PDP's brightness is proportional to the number of sustain discharge pulses applied during sustain discharge periods S1, . . . , S8 in a unit frame. If a frame forming one image is displayed by 8 sub-fields in 256 gray-scales, different numbers (1, 2, 4, 8, 16, 32, 64, and 128) of sustain pulses may be sequentially assigned to the sub-fields. In this case, in order to obtain the brightness of a 133 gray-scale level, cells may be addressed and sustain-discharged during the periods of a first sub-field (SF1), a third sub-field (SF3), and an eighth sub-field (SF8).

FIG. 3 is a timing diagram of exemplary driving signals for driving a PDP. FIG. 3 shows driving signals applied to address electrodes A1, A2, . . . , Am, X electrodes X₁, X₂, . . . , Xₙ, and Y electrodes Y₁, Y₂, . . . , Yₙ in a sub-field SFₙ according to an ADS driving method of an alternating current (AC) PDP. Referring to FIG. 3, a sub-field SFₙ includes a reset period PR, an address period PA, and a sustain-discharge period PS.

During the reset period PR, a reset pulse is applied to Y electrodes to perform write discharges, thereby initializing the state of wall charges in all cells. The reset period PR is performed over the whole screen before the address period PA to uniformly distribute wall charges in all cells. During the reset period PR, applying a reset voltage with a rising ramp-shaped waveform to the Y electrodes Y₁ through Yₙ generates a first weak discharge, thereby accumulating a large amount of negative charges on the Y electrodes Y₁ through Yₙ. Then, applying a reset voltage with a falling ramp-shaped waveform to the Y electrodes Y₁ through Yₙ generates a second weak discharge, thereby discharging a portion of the negative charges accumulated on the Y electrodes Y₁ through Yₙ, so that wall charges in all cells may be in a similar state and all cells are initialized. FIG. 4A shows the state of wall charges when a normal reset discharge is generated. Referring to FIG. 4A, a large amount of negative charges accumulate on a dielectric layer portion 11, 12 below a Y electrode Yₙ, and a small amount of positive charges accumulate on a dielectric layer portion 11, 12 below an X electrode Xₙ and on a dielectric layer 15 over an address electrode A_{Rm} within a discharge space 14. Reference numeral 12 denotes a protective layer, which may be formed on the dielectric layer 11.

After performing the reset period PR, the address period PA is performed. During the address period PA, a bias voltage Vₑ is applied to the X electrodes X₁ through Xₙ, and Y electrodes Y₁ through Yₙ and address electrodes A₁ through Aₘ of cells to be displayed are simultaneously turned on to select those cells. During the address period PA, applying a negative scanning pulse to the Y electrodes Y₁ through Yₙ and an address data voltage Vₐ to the address electrodes A₁ through Aₘ generates an address discharge. The address discharge occurs when a potential difference (this is a unique value depending on the physical structure of a PDP), between a sum of the voltage of the negative scanning pulse and a voltage created by the negative charges accumulated on the Y electrodes, and a sum of the positive address data voltage and a voltage created by the positive charges accumulated on the address electrodes, exceeds a discharge start voltage. FIG. 4B is a view showing the state of wall charges when an address discharge occurs in a selected cell after a normally generated reset discharge. The address discharge accumulates positive charges on a dielectric layer portion 11, 12 below a Y electrode Yₙ and negative charges on a dielectric layer portion 11, 12 below an X electrode Xₙ.

After performing the address period PA, a sustain pulse V_{S} is alternately applied to the X electrodes and the Y electrodes to perform a sustain discharge period PS. Display cells are selected and sustain-discharge is generated by the distribution (that is, a state where a large amount of positive charges are accumulated near the scan electrodes) of the wall charges formed by the address discharge. During the sustain-discharge, phosphors 16 applied on dielectric layer 15 covering the address electrodes are excited by ultraviolet radiation caused by the discharge between the Y electrodes and X electrodes, thereby emitting light. During the sustain-discharge period PS, a low-level voltage V_{G} is applied to the address electrodes A₁ through Aₘ.

The sustain-discharge occurs when a potential difference between a sum of a voltage of a positive sustain pulse and a voltage created by the positive wall charges accumulated on the Y electrodes of the cells selected during the address period, and a voltage created by the negative wall charges accumulated on the X electrodes of the cells, exceeds a discharge start voltage. FIG. 4C is a view showing the state of wall charges when a sustain-discharge occurs in a selected cell after a normally generated reset discharge. Referring to 4C, during a sustain-discharge period, a predetermined number of sustain pulses, which is set according to weights of sub-fields, is alternately applied to a Y electrode Yₙ and an X electrode Xₙ.

However, according to the physical state inside discharge cells, a strong discharge may occur while applying a rising or falling ramp waveform during a reset period. Since a strong reset discharge creates an abnormal state of wall charges, discharge is not normally performed during the following address period and sustain-discharge period.

FIG. 5A is a view showing the state of wall charges when a strong discharge occurs during a reset period. Referring to FIG. 5A, a strong discharge accumulates positive charges on a dielectric layer portion 11, 12 below a Y electrode Yₙ. In this case, a sustain-discharge may occur in non-selected cells.

That is, after an address period, positive charges should be accumulated only on Y electrodes of selected cells, and negative charges should be accumulated on Y electrodes of non-selected cells. However, as shown in FIG. 5B, if reset discharge is abnormally generated, the state of the charges walls shown in FIG. 5A remains as it is after the address period, whereby positive charges remain accumulated on Y electrodes in non-selected cells. In this state, if a sustain pulse of a positive voltage is applied to the Y electrodes in the non-selected cells during the following sustain-discharge period, a voltage created by the positive charges accumulated on the Y electrode is added with the voltage of the sustain pulse, and the total voltage may exceed a discharge start voltage, thereby resulting in generating a discharge in non-selected cells, as shown in FIG. 5C.

If sustain discharge occurs in non-selected cells, contrast and picture quality deteriorate. A strong discharge may be generated since a ramp waveform applied to generate only a weak discharge during a reset period does not have perfect reliability.

In particular, as shown in FIG. 6, in a driving method of using both a main reset waveform and a sub reset waveform during a reset period of two sub-fields, a probability of generating a strong discharge is high while applying the main reset waveform to accumulate a large amount of negative charges.

### SUMMARY OF THE INVENTION

The present invention provides a plasma display panel (PDP) driving method capable of improving reliability in a reset operation for initializing the state of wall charges of the PDP's discharge cells.

The present invention also provides a PDP driving method that may substantially normalize the state of wall charges even when initializing of discharge cells of a PDP fails.

The present invention also provides a PDP driving method that may more reliably perform a reset operation and represent gray-scale levels, as well as enhance the contrast of a displayed picture.

Additional features of the invention will be set forth in the description which follows, and in part will be apparent from the description, or may be learned by practice of the invention.

The present invention discloses a driving method of a plasma display panel, the plasma display panel including an address electrode and a first electrode and a second electrode arranged substantially orthogonal to the address electrode, in which gray-scale levels are represented using a reset period, an address period, and a sustain-discharge period. The method includes, in a reset period of a first sub-field, applying a rising ramp pulse and a falling ramp pulse to the first electrode, thus initializing wall charges of a discharge cell, wherein a self-erase discharge is generated if a strong discharge occurs between the first electrode and the second electrode, and in a reset period of a second sub-field, applying a falling ramp pulse to the first electrode.

The present invention also discloses an apparatus for driving a plasma display panel, the plasma display panel including a first electrode and a second electrode. The apparatus includes a sustain pulse generator alternately supplying a sustain pulse to the first electrode and the second electrode, a first ground potential applying unit applying a ground potential to the first electrode, a rising ramp generator applying a ramp waveform rising from a reset start voltage to a reset maximum voltage to the first electrode, a first falling ramp generator applying a ramp waveform falling to a first reset minimum voltage to the first electrode and applying a bias voltage for increasing a potential difference between the first electrode and the second electrode to the first electrode at the first reset minimum voltage, a second falling ramp generator applying a ramp waveform falling from the reset start voltage to a second reset minimum voltage to the first electrode, and a scan pulse generator applying a scan pulse changing between a high scan voltage and a low scan voltage to the first electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows an electrode arrangement of a PDP.

FIG. 2 is a view for explaining a conventional address-display separation driving method for driving Y electrode lines of a PDP.

FIG. 3 is a timing diagram of exemplary driving signals for driving a PDP.

FIG. 4A is a view showing the state of wall charges when a normal reset discharge is generated.

FIG. 4B is a view showing the state of wall charges when an address discharge occurs in a selected cell after a normally generated reset discharge.

FIG. 4C is a view showing the state of wall charges when a sustain-discharge occurs in a selected cell after a normally generated reset discharge.

FIG. 5A is a view showing the state of wall charges when an abnormal reset discharge is generated.

FIG. 5B is a view showing the state of wall charges after an address period in a non-selected cell having an abnormally generated reset discharge.

FIG. 5C is a view showing the state of wall charges when a sustain-discharge is generated in a non-selected cell after an abnormally generated reset discharge.

FIG. 6 is a timing diagram showing a driving method of using both a main reset waveform and a sub reset waveform.

FIG. 7 is a perspective view of a PDP.

FIG. 8 is a block diagram of a general driving apparatus of a PDP.

FIG. 9 is a timing diagram for explaining a driving signal for driving a PDP according to an exemplary embodiment of the present invention.

FIG. 10 is a timing diagram for explaining a driving signal for driving a PDP according to a first embodiment of the present invention.

FIG. 11 is a timing diagram for explaining a driving signal for driving a PDP according to a second embodiment of the present invention.

FIG. 12 is a view for explaining self-erase discharge employed in a PDP driving method according to an embodiment of the present invention.

FIG. 13 is a circuit diagram of a driving apparatus for implementing a PDP driving method according to a first embodiment of the present invention.

FIG. 14 is a circuit diagram of a driving apparatus for implementing a PDP driving method according to a second embodiment of the present invention.

FIG. 15 is a circuit diagram of a driving apparatus for implementing a PDP driving method according to a third embodiment of the present invention.

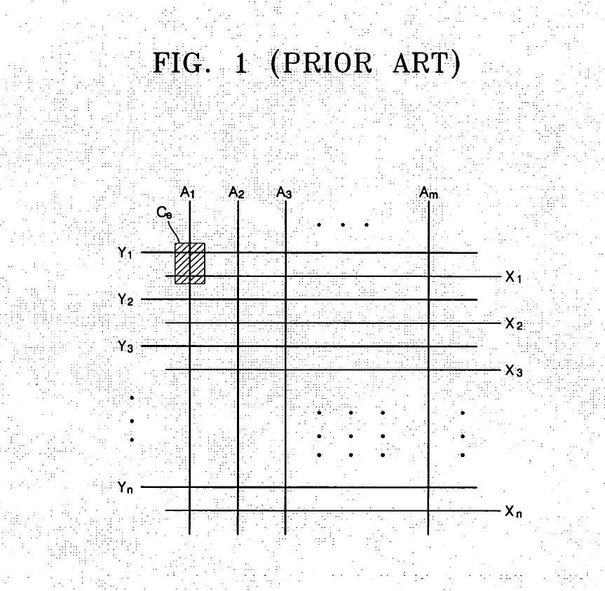

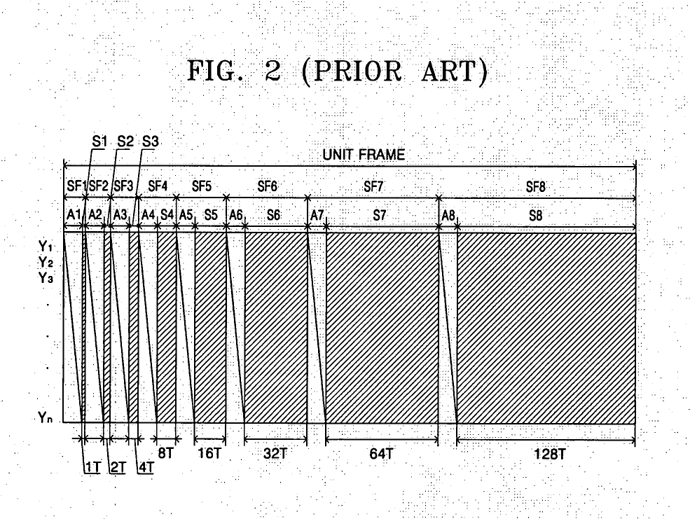

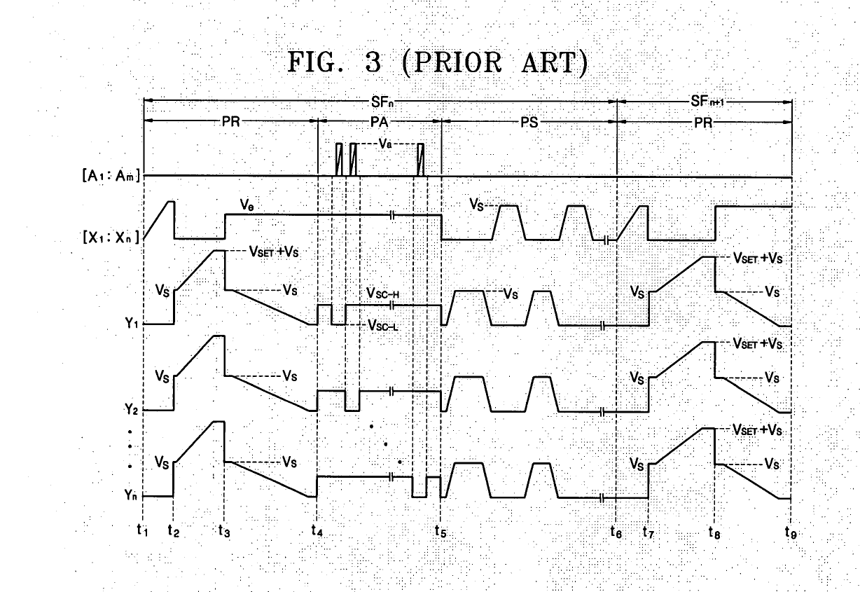

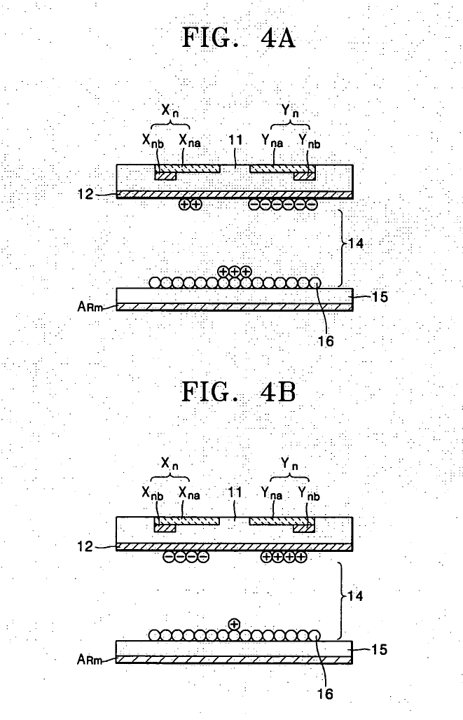

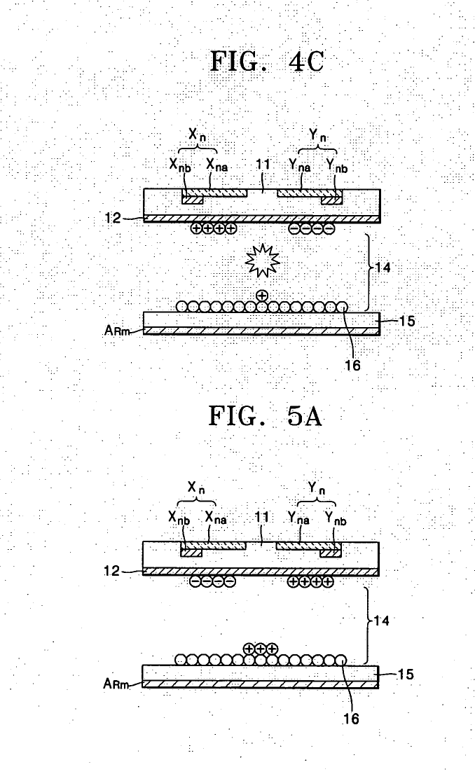

### DETAILED DESCRIPTION OF THE ILLUSTRATED EMBODIMENTS

Hereinafter, exemplary embodiments of the present invention will be described in detail with reference to the appended drawings.

In a PDP driving method according to an embodiment of the present invention, which represents gray-scale levels by sub-fields including a reset period, an address period, and a sustain period in order to control the state of wall charges in the PDP's discharge cells, a voltage waveform for normally setting the state of the wall charges is applied to prevent an unintentionally strong discharge during a reset period from initializing discharge cells, so that reliability of the reset period may improve, reliability in gray-scale representation may improve, and the contrast of a displayed picture increases.

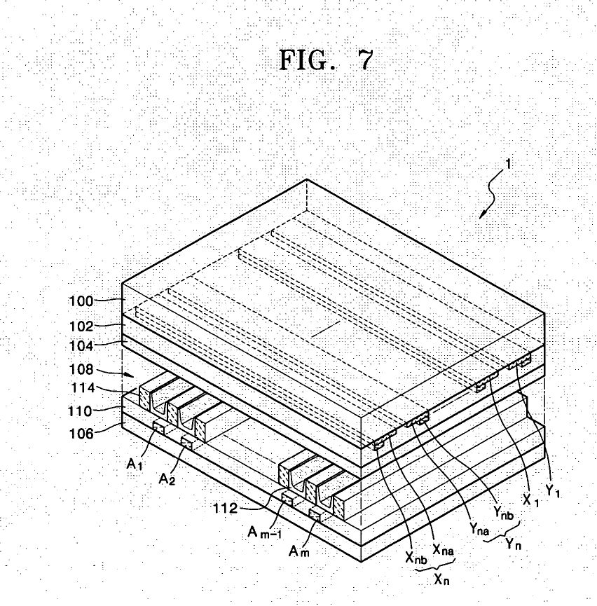

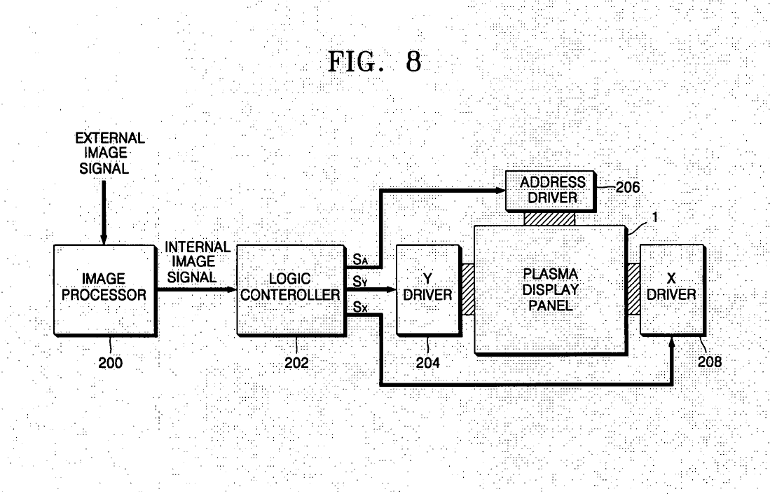

FIG. 7 is a perspective view of a PDP 1.

Referring to FIG. 7, address electrode lines A₁, A₂, . . . , Aₘ, first and second dielectric layers 102 and 110, Y electrode lines Y₁, Y₂, . . . , Yₙ, X electrode lines X₁, X₂, . . . , Xₙ, phosphor layers 112, barrier ribs 114, and a protective layer 104 are provided between a first substrate 100 and a second substrate 106.

The address electrode lines A₁, A₂, . . . , Aₘ are formed with a predetermined pattern on a surface of the second substrate 106 facing the first substrate 100. The second dielectric layer 110 covers the address electrode lines A₁, A₂, . . . , Aₘ. The barrier ribs 114 are formed parallel to the address electrode lines A₁, A₂, . . . , Aₘ and on the second dielectric layer 110. The barrier ribs 114 demarcate discharge areas of display cells to thus prevent optical interference between the display cells. The phosphor layers 112, including sequentially arranged R, G, and B emitting phosphor layers, are formed on sides of the barrier ribs 114 and on the second dielectric layer 110.

The X electrode lines X₁, X₂, . . . , Xₙ and the Y electrode lines Y₁, Y₂, . . . , Yₙ are formed with a predetermined pattern on a surface of the first substrate 100 facing the second substrate 106, and they are arranged to orthogonally intersect the address electrode lines A₁, A₂, . . . , Aₘ. Each intersection of an address electrode with an X and Y electrode pair forms a corresponding discharge cell. Each X electrode line X₁, X₂, . . . , Xₙ may include a transparent electrode Xₙₐ formed of transparent conductive material such as indium tin oxide (ITO) and a metal electrode X_{nb} for increasing conductivity. Each Y electrode line Y₁, Y₂, . . . , Yₙ may also include a transparent electrode Yₙₐ formed of a transparent conductive material such as ITO and a metal electrode Y_{nb} for increasing conductivity. The first dielectric layer 102 covers the X electrode lines X₁, X₂, . . . , Xₙ and the Y electrode lines Y₁, Y₂, . . . , Yₙ. The protective layer 104 protects the panel from a strong electric field, and it may be made of, for example, a MgO layer that covers the first dielectric layer 102. A discharge space 108 is filled with plasma forming gas and then sealed.

In a widely used conventional PDP driving method, a resetting operation, an addressing operation, and a sustain-discharge operation are sequentially performed in a unit sub-field. During the resetting operation, charges in all discharge cells are uniformly distributed. During the addressing operation, the state of charges in discharge cells to be turned on (i.e. selected) and the state of charges in discharge cells not to be turned on are set. During the sustain-discharge operation, sustain-discharge is performed on selected discharge cells. At this time, plasma is generated from the plasma forming gas in the discharge cells on which sustain discharge has been performed, and the phosphor layers of the discharge cells are excited by ultraviolet radiation caused by the plasma, thus emitting light.

PDP driving methods according to embodiments of the present invention may be applied to PDPs with the structure described above, as well as to all types of PDPs capable of being driven by a driving waveform having a reset period.

FIG. 8 is a block diagram showing a general PDP driving apparatus.

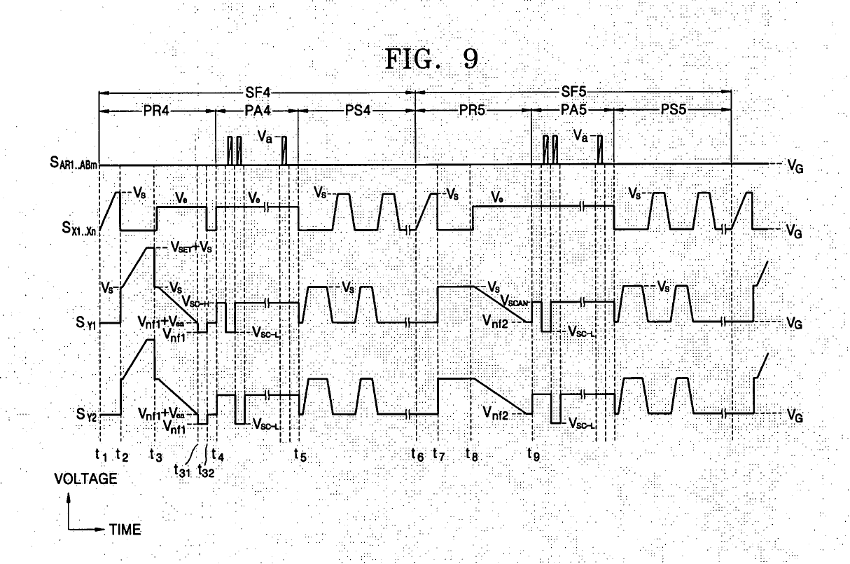

Referring to FIG. 8, the PDP driving apparatus includes an image processor 200, a logic controller 202, an address driver 206, an X driver 208, and a Y driver 204. The image processor 200 converts, as necessary, an external image signal into a digital signal, and generates an internal image signal, for example, R/G/B image data, a clock signal, or horizontal and vertical synchronization signals, each having 8 bits. The logic controller 202 generates driving control signals S_{A}, S_{Y}, and S_{X} in response to the internal image signal received from the image processor 200. The address driver 206 processes the address driving control signal S_{A} to generate a display data signal, and applies the generated display data signal to the address electrode lines. The X driver 208 processes the X driving control signal S_{X} and applies the processed result to the X electrode lines. The Y driver 204 processes the Y driving control signal S_{Y} and applies the processed result to the Y electrode lines. 591 FIG. 9 is a timing diagram of a driving signal for driving a PDP according to an embodiment of the present invention. Hereinafter, a case is described where a main reset pulse is applied during a reset period PR4 of a fourth sub-field SF4 and a sub reset pulse is applied during a reset period PR5 of a fifth sub-field SF5. However, the present invention is not limited to this case.

Referring to FIG. 9, during the reset period PR4 of the fourth sub-field SF4, a reset pulse is applied to all groups of scan lines to compulsorily perform a write discharge, thereby initializing the state of wall charges in all cells. The reset period PR is performed over the whole screen before the address period PA to substantially uniformly distribute wall charges in all cells. That is, wall charges in cells initialized during the reset period PR are in a similar state.

During the reset period PR4 according to an embodiment of the present invention, a rising ramp pulse (between t₂ and t₃) is applied to Y electrode lines Y₁, Y₂, . . . , Yₙ to perform a first initialization discharge, and, then, a falling ramp pulse (between t₃ and t₃₁) is applied to the Y electrode lines Y₁, Y₂, . . . , Yₙ to perform a second initialization discharge. The first initialization discharge refers to a weak discharge that is generated to accumulate negative charges near the Y electrode lines Y₁, Y₂, . . . , Yₙ (i.e., near a dielectric layer on the Y electrode lines) while applying the rising ramp pulse (between t₂ and t₃) with a gradual slope to the Y electrode lines Y₁, Y₂, . . . , Yₙ.

In order to reduce the time taken to generate the first initialization discharge, the rising ramp pulse may rise from a first voltage V_{S}, being a predetermined reset start voltage, to a maximum voltage V_{SET}+V_{S}.

During the second initialization discharge, the falling ramp pulse is applied to the Y electrode lines Y₁, Y₂, . . . , Yₙ, and a portion of the negative charges accumulated near the Y electrode lines Y₁, Y₂, . . . , Yₙ (i.e., near the dielectric layer on the Y electrode lines) are discharged to generate a weak discharge. After the second initialization discharge, enough negative charges to generate an address discharge remain near the Y electrode lines Y₁, Y₂, . . . , Yₙ. Here, the falling ramp pulse applied to the Y electrode lines Y₁, Y₂, . . . , Yₙ has a gradual slope to prevent a strong discharge. The falling ramp pulse may be applied after decreasing the Is maximum voltage V_{SET}+V_{S} to the first voltage V_{S}, thereby reducing the time taken to generate the second initialization discharge.

After performing the main reset period PR4, the address period PA4 (between t₄ and t₅) is performed. During the address period PA4, address data is applied to address electrode lines A₁, A₂, . . . , Aₘ, and simultaneously, a scan pulse changing between a high scan voltage V_{SC-H} and a low scan voltage, V_{SC-L} is sequentially applied to the Y electrode lines Y₁, Y₂, . . . , Yₙ. That is, simultaneously turning on Y electrode lines Y₁, Y₂, . . . , Yₙand address electrode lines A₁, A₂, . . . , Aₘ of corresponding cells to be turned on generates an address discharge to select the corresponding display cells. During the address period PA4, the address discharge occurs by energy (i.e., the sum of absolute values of all potentials) resulting from subtracting a sum of the low scan voltage V_{SC-L} of the scanning pulse applied to the Y electrode lines Y₁, Y₂, . . . , Yₙ and a potential created by the negative charges accumulated near the Y electrode lines, from a sum of a voltage Vₐ of the display data signal and a potential created by positive charges accumulated near the address electrode lines A₁, A₂, . . . , Aₘ.

After performing the address period PA, a sustain pulse is alternately applied to the X electrode lines X₁, X₂, . . . , Xₙ and the Y electrode lines Y₁, Y₂, . . . , Yₙ to perform a sustain discharge period PS4 (between t₅ and t₆). A low-level voltage (ground potential) V_{G} is applied to the address electrodes A₁, A₂, . . . , Aₘ during the sustain discharge period PS4. The PDP's brightness depends on the number of sustain pulses. As the number of sustain pulses applied in a sub-field or in a TV field increases, the PDP's brightness also increases.

However, if an abnormal strong discharge occurs during the second initialization discharge, positive charges accumulate near the Y electrode lines Y₁, Y₂, . . . , Yₙ instead of negative charges. Accordingly, due to the effect of wall voltage, sustain discharge may occur in non-selected cells that have positive charges accumulated on the Y electrodes.

In the PDP driving method according to an embodiment of the present invention, in order to erase the positive charges accumulated on the Y electrodes Y₁, Y₂, . . . , Yₙ due to an abnormally generated strong discharge in the main reset period PR4, in the charge accumulation period t₃₁-t₃₂, a sum of a bottom voltage V_{nf1}+Vₑₐ and a bias voltage −Vₑₐ is applied to the Y electrodes Y₁, Y₂, . . . , Yₙ, thereby increasing a potential difference between the Y electrodes Y₁, Y₂, . . . , Yₙ and the X electrodes X₁ through Xₙ and setting the state of wall charges to allow a self-erase discharge. Then, in the following ground neutralization period t₃₂-t₄, the same voltage is applied to the X electrodes X₁, X₂, . . . , Xₙ and the Y electrodes Y₁, Y₂, . . . , Yₙ, thereby performing the self-erase discharge of the wall charges and neutralizing the wall charges. As used herein, erase does not require complete removal of all traces of the thing being erased.

In the sub reset period PR5 of the fifth sub-field SF5, since the probability of generating a strong discharge is low, the self-erase discharge and neutralization are not needed, unlike the main reset period PR4. Accordingly, in the sub reset period PR5, the bias voltage −Vₑₐ is not added to a second reset minimum voltage V_{nf2}. Here, the second reset minimum voltage V_{nf2} may have the same amplitude as the first reset minimum voltage V_{nf1}+Vₑₐ or they may be different. However, if they are the same, circuit components can be shared, thereby reducing the cost of manufacturing the driving apparatus.

In the panel driving method according to an embodiment of the present invention, during the main reset period PR4, the wall charges accumulated on the address electrodes Aₗ through Aₘ, the Y electrodes Y₁ through Yₙ, and the X electrodes X₁ through Xₙ are initialized, demagnetization discharge occurs when a strong discharge is generated between the Y electrodes Y₁ through Yₙ and the X electrodes X₁ through Xₙ, and no demagnetization discharge is generated during the sub reset period PR5.

During the address periods PA4 and PA5, a scan pulse changing between a high scan voltage V_{SC-H} and a low scan voltage V_{SC-L} is sequentially applied to the Y electrodes Y₁ through Yₙ, and address data is applied to the address electrodes A₁ through Aₘ, to select discharge cells. During the sustain-discharge periods PS4 and PS5, a sustain pulse with a sustain voltage is alternately applied to the Y electrodes Y₁ through Yₙ and the X electrodes X₁ through Xₙ to generate sustain-discharge in the selected discharge cells only.

In particular, during the main reset period PR4, a rising ramp-shaped pulse rising from a reset start voltage V_{S} to a reset maximum voltage V_{SET}+V_{S}, a falling ramp-shaped pulse falling to a first reset minimum voltage V_{nf1}+Vₑₐ, and a bias voltage −Vₑₐ starting from the first reset minimum voltage V_{af1}+Vₑₐ are applied to the Y electrodes Y₁ through Yₙ. The added bias voltage −Vₑₐ increases a potential difference between the Y electrodes Y₁ through Yₙ and the X electrodes X₁ through Xₙ. The amplitude of the first bias voltage −Vₑₐ may be set so that the potential difference between a voltage +ΔVY of the Y electrodes and a voltage +ΔVX of the X electrodes exceeds a discharge start voltage. The voltage +ΔVY of the Y electrodes is formed by a sum of a voltage created by positive wall charges accumulated on the Y electrodes Y₁ through Yₙ when the strong discharge occurs and a voltage created by positive wall charges accumulated by the first bias voltage −Vₑₐ. The voltage +ΔVX of the X electrodes is created by negative wall charges accumulated on the X electrodes X₁ through Xₙ.

Also, in the sub-field SF4 during which the main reset period is performed, after applying the bias voltage 31 Vₑₐ to the Y electrodes Y₁ through Yₙ, a neutral voltage is applied to the Y electrodes Y₁ through Yₙ and the X electrodes X₁ through Xₙ. The neutral voltage may be a ground voltage V_{G}. Applying the neutral voltage generates the self-erase discharge between the positive wall charges accumulated on the Y electrodes Y₁ through Yₙ and the negative wall charges accumulated on the X electrodes X₁ through Xₙ.

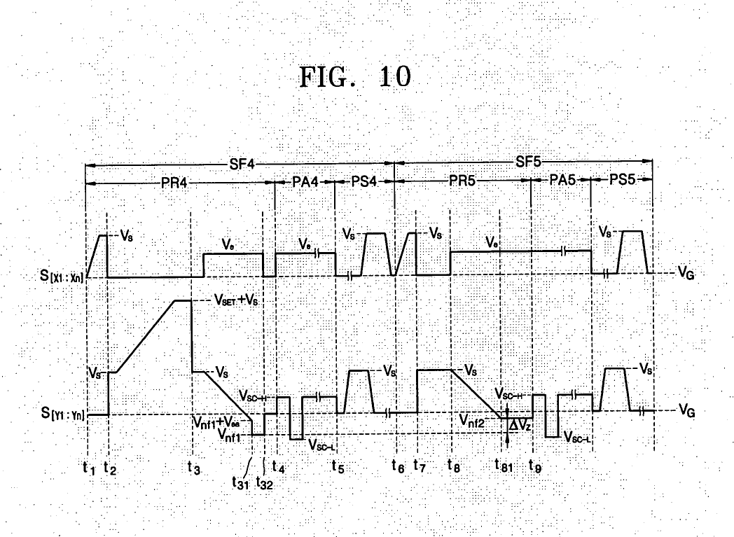

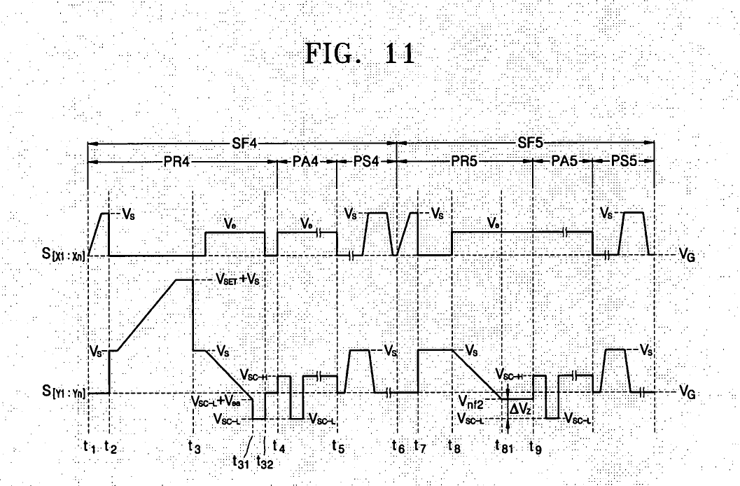

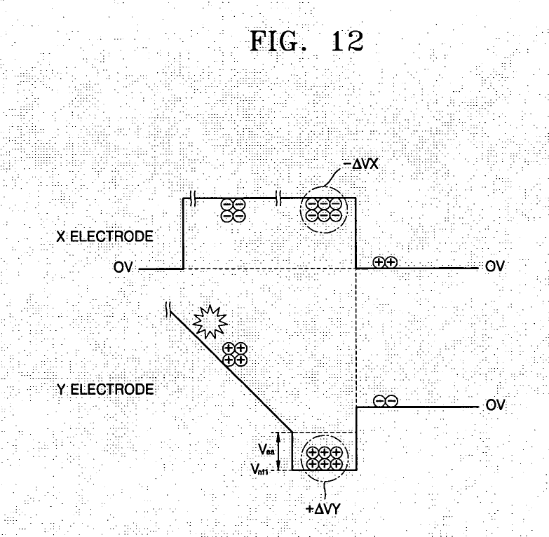

FIG. 10 is a timing diagram for explaining a driving signal for driving a PDP according to a first embodiment of the present invention. FIG. 12 is a view for explaining the self-erase discharge employed in a PDP driving method according to an embodiment of the present invention. Hereinafter, the PDP driving method is described with reference to FIG. 10 and FIG. 11. In FIG. 10 and FIG. 11, only a fourth sub-field SF4 and a fifth sub-field SF5 are described, however, the present invention is not limited to these sub-fields. Also, electrodes and electrode lines have the same meaning and, for the convenience of description, a plurality of electrodes (electrode lines) and an electrode (electrode line) are used without distinction in the above description, however, the present invention is not limited to these.

For example, during the time t₃-t₃₁ in the main reset period PR4 of the fourth sub-field SF4 of FIG. 10, a positive bias voltage Vₑ is applied to the X electrodes X₁ through Xₙ and a falling ramp-shaped voltage falling to the first reset minimum voltage V_{nf1}+Vₑₐ is applied to the Y electrodes Y₁ through Yₙ. If a strong discharge is abnormally generated when applying the falling ramp-shaped voltage, positive charges accumulate on the Y electrodes Y₁ through Yₙ and negative charges accumulate on the X electrodes X₁ through Xₙ, as shown in FIG. 12.

After the falling ramp-shaped voltage reaches the first reset minimum voltage V_{nf1}+Vₑₐ, a bias voltage −Vₑₐ, which increases a potential difference between the Y electrodes and the X electrodes, is further applied to the Y electrodes Y₁ through Yₙ. That is, during the following time t₃₁-t₃₂, a bottom voltage V_{nf1} (i.e. the first reset minimum voltage V_{nf1}+Vₑₐ lowered by the bias voltage Vₑₐ) is applied to the Y electrodes Y₁ through Yₙ. Accordingly, the bias voltage −Vₑₐ accumulates additional positive charges on the Y electrodes Y₁ through Yₙ, which are added to the positive charges accumulated on the Y electrodes Y₁ through Yₙ by the strong discharge. Further, additional negative charges accumulate on the X electrodes X₁ through Xₙ due to the potential difference between the Y electrodes Y₁ through Yₙ and the X electrodes X₁ through Xₙ.

Accordingly, wall charges accumulate during the time t₃-t₃₁ when applying the falling ramp pulse, and more wall charges accumulate during the time t₃₁-t₃₂. If a voltage created by the negative wall charges accumulated on the X electrodes X₁ through Xₙ is −ΔVX, and a voltage created by the positive wall charges accumulated on the Y electrodes Y₁ through Yₙ is +ΔVY, a voltage difference ΔVX+ΔVY between the X electrodes X₁ through Xₙ and the Y electrodes Y₁ through Yₙ exceeds a discharge start voltage V_{f}. In other words, the bias voltage −Vₑₐ is added with the first reset minimum voltage V_{nf1}+Vₑₐ so that the voltage difference ΔVX+ΔVY, which is generated by wall charges additionally formed after the strong discharge is erroneously generated in a reset period, is larger than the discharge start voltage V_{f}.

Thereafter, in the time t₃₂-t₄, the same voltage is applied to the X electrodes X₁ through Xₙ and the Y electrodes Y₁ through Yₙ, resulting in a zero potential difference ΔVX+ΔVY between the X electrodes X₁ through Xₙ and the Y electrodes Y₁ through Yₙ, thereby generating the self-erase discharge and neutralizing the wall charges between the X electrodes X₁ through Xₙ and the Y electrodes Y₁ through Yₙ. Therefore, when the strong discharge is generated in the main reset period PR4, the positive charges accumulated on the Y electrodes Y₁ through Yₙ are erased and the state of the wall charges change to similar to that of wall charges of normally reset discharge cells.

Therefore, according to embodiments of the present invention, it is possible to prevent non-selected cells from being sustain-discharged even when a strong discharge is abnormally generated in a main reset period PR4.

While a neutral voltage is applied to the X electrodes X₁ through Xₙ and the Y electrodes Y₁ through Yₙ, the X bias voltage Vₑ may be essentially applied to the X electrodes X₁ through Xₙ if the X bias voltage Vₑ is not equal to the neutralization voltage. Since the neutral voltage is not applied to the Y electrodes Y₁ through Yₙ during the sub reset period PR5 of the fifth sub-field SF5, the X bias voltage Vₑ may be continuously applied to the X electrodes X₁ through Xₙ.

The sustain pulse with the sustain voltage V_{S} applied during the sustain-discharge period has a predetermined amplitude that does not allow a sustain-discharge even though the self-erase discharge is generated in the reset period. This is because some wall charges may exist on the X electrodes and Y electrodes even though the self-erase discharge is generated in the reset period, and if the sustain voltage V_{S} is too high, a sum of the sustain voltage V_{S} and the voltage +ΔVY may exceed the discharge start voltage.

Also, the bias voltage −Vₑₐ applied to the Y electrodes in addition to the first reset minimum voltage V_{nf1}+Vₑₐ is higher than a voltage at which no address discharge occurs in the following address period by causing positive wall charges accumulated by the bias voltage −Vₑₐ to erase negative wall charges accumulated on the Y electrodes without a strong discharge. This is because if the negative wall charges accumulated on the Y electrodes are reduced too much even though the main reset operation is normally performed, reliability of the address discharge deteriorates.

Since the probability of generating the strong discharge is low in the sub reset period PR5 of the fifth sub-field SF5, the self-erase discharge and neutralization are not needed, unlike in the main reset period PR4. Accordingly, during a time t₈₁-t₉ in the sub reset period PR5 of the fifth sub-field SF5, the bias voltage −Vₑₐ is not added to a second reset minimum voltage V_{nf2}. Here, the second reset minimum voltage V_{nf2} may have an amplitude equal to or different from the first reset minimum voltage V_{nf1}+Vₑₐ. If the second reset minimum voltage V_{nf2} has the same amplitude as the first reset minimum voltage V_{nf1}+Vₑₐ, circuit components may be shared, thereby reducing the manufacturing cost of the PDP driving apparatus.

FIG. 11 is a timing diagram for explaining a driving signal for driving a PDP according to a second embodiment of the present invention. The PDP driving method according to the second embodiment of the present invention is characterized in that, in a main reset period PR4, a bottom voltage applied in a time t₃₁-t₃₂ is the same as a low scan voltage V_{SC-L}.

For example, as shown in FIG. 11, during a time t₃-t₃₁ in a main reset period PR4 of a sub-field SF4, a positive X bias voltage Vₑ is applied to X electrodes X₁ through Xₙ and a falling ramp-shaped voltage falling to a first reset minimum voltage V_{SC-L}+Vₑₐ is applied to the Y electrodes Y₁ through Yₙ. The first reset minimum voltage V_{SC-L}+Vₑₐ has a potential that is higher by a magnitude Vₑₐ of the bias voltage than the scan low voltage V_{SC-L}. That is, the magnitude Vₑₐ of the bias voltage is a value resulting from subtracting the low scan voltage V_{SC-L} from a first reset minimum voltage V_{SC-L}+Vₑₐ.

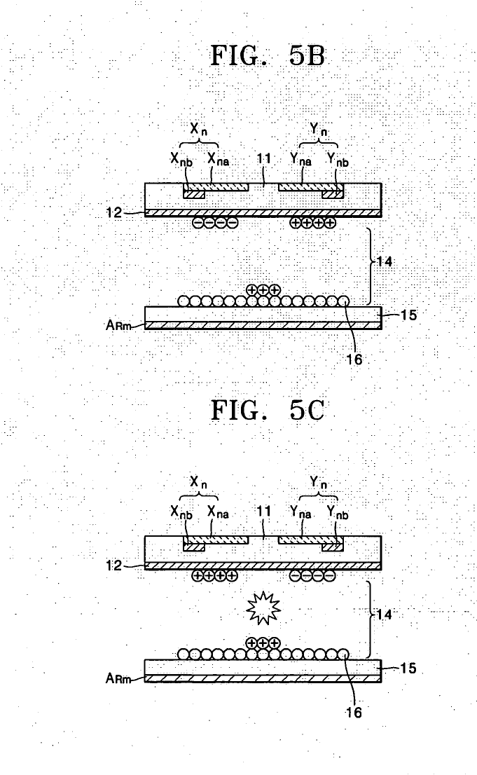

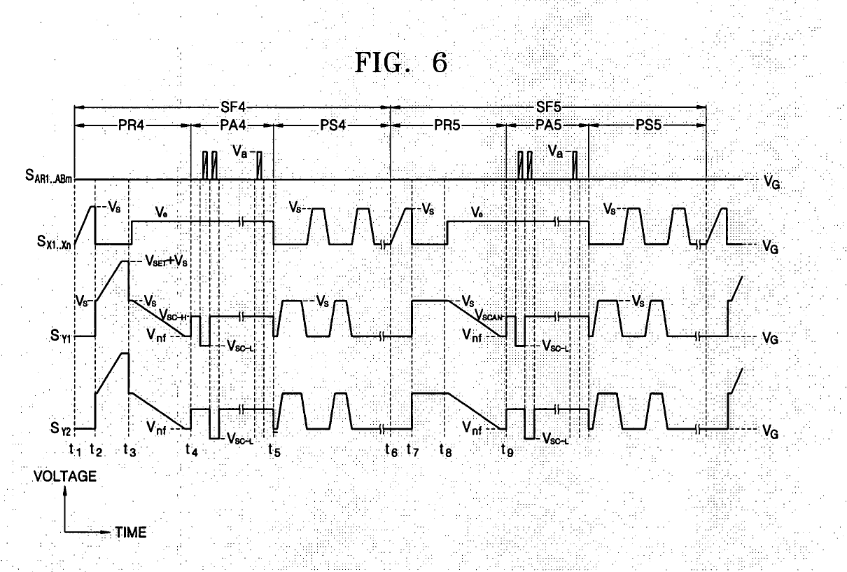

If a strong discharge is generated when applying the falling ramp-shaped voltage, positive charges accumulate on the Y electrodes Y₁ through Yₙ and negative charges accumulate on the X electrodes X₁ through Xₙ, as shown in FIG. 5A.

When the falling ramp-shaped voltage reaches the first reset minimum voltage V_{SC-L}+Vₑₐ, a bias voltage −Vₑₐ, which increases the potential difference between the Y electrodes Y₁ through Yₙ and the X electrodes X₁ through Xₙ, is additionally applied to the Y electrodes Y₁ through Yₙ. That is, during the times t₃₁-t₃₂, a bottom voltage V_{SC-L} (i.e. the first reset minimum voltage V_{SC-L}+Vₑₐ lowered by the bias voltage −Vₑₐ) is applied to the Y electrodes Y₁ through Yₙ. Accordingly, the bias voltage −Vₑₐ causes positive charges to accumulate on the Y electrodes Y₁ through Yₙ in addition to the positive charges already accumulated on the Y electrodes Y₁ through Yₙ due to the strong discharge. Also, due to the potential difference between the Y electrodes Y₁ through Yₙ and the X electrodes X₁ through Xₙ, negative charges additionally accumulate on the X electrodes X₁ through Xₙ.

Accordingly, wall charges accumulate during the time t₃-t₃₁ when applying the falling ramp pulse, and more wall charges accumulate during the time t₃₁-t₃₂. If a voltage created by the negative wall charges accumulated on the X electrodes X₁ through Xₙ is −ΔVX, and a voltage created by positive wall charges accumulated on the Y electrodes Y₁ through Yₙ is +ΔVY, the amount of accumulated wall charges is sufficient enough that the potential difference ΔVY+ΔVX between the X electrodes X₁ through Xₙ and the Y electrodes Y₁ through Yₙ exceeds a discharge start voltage V_{f}. In other words, the bias voltage −Vₑₐ may provide a voltage difference ΔVX+ΔVY between the X electrodes X₁ through Xₙ and the Y electrodes Y₁ through Yₙ, which is generated by wall charges additionally provided after a strong discharge is generated in the reset period, that exceeds the discharge start voltage V_{f}.

Thereafter, in the following time t₃₂-t₄, the same voltage is applied to the X electrodes X₁ through Xₙ and the Y electrodes Y₁ through Yₙ, resulting in a zero potential difference ΔVX+ΔVY between the X electrodes X₁ through Xₙ and the Y electrodes Y₁ through Yₙ, thereby generating the self-erase discharge and neutralizing wall charges of the X electrodes X₁ through Xₙ and the Y electrodes Y₁ through Yₙ. Therefore, when a strong discharge is generated in a reset period, positive charges accumulated on Y electrodes Y₁ through Yₙ are erased, so that the state of wall charges in corresponding discharge cells becomes similar to that of wall charges in normally reset discharge cells. Hence, it is possible to prevent non-selected cells from being sustain-discharged during the sustain-discharge period even though a strong discharge is generated in the non-selected cells in a reset period.

Also, in the PDP driving method according to the second embodiment of the present invention, since a driving circuit that applies a bias voltage −Vₑₐ during a main reset period PR4, and a driving circuit that applies a low scan voltage V_{SC-L} during the address period, to the Y electrodes Y₁ through Yₙ may be shared, manufacturing costs of a PDP driving apparatus may be reduced.

The PDP driving method of the present invention may also be embodied as computer readable code on a computer readable recording medium. The computer readable recording medium is any data storage device that can store data that can be read by a computer system. Examples of the computer readable recording medium include read-only memory (ROM), random-access memory (RAM), CD-ROMs, magnetic tapes, floppy disks, optical data storage devices, and carrier waves. The computer readable recording medium may also be distributed over network coupled computer systems so that the computer readable code is stored and executed in a distributed fashion.

In particular, the program for executing the panel driving method may be written in schematic or Very high speed integrated circuit Hardware Description Language (VHDL) and be executed by a programmable integrated circuit, for example, Field Programmable Gate Array (FPGA). The recording medium includes the programmable integrated circuit.

The present invention also provides a PDP driving apparatus.

The PDP driving apparatus according to embodiments of the present invention may include a sustain pulse generator alternately applying a sustain pulse to an X electrode and a Y electrode; a first ground potential applying unit applying a ground potential to the Y electrode; a rising ramp generator applying a ramp waveform rising from a reset start voltage to a reset maximum voltage V_{SET}+V_{S} to the Y electrode; a first falling ramp generator applying a ramp waveform falling to the first reset minimum voltage V_{nf1}+Vₑₐ to the Y electrode, and applying a bias voltage −Vₑₐ for increasing a potential difference between the Y electrode and the X electrode, to the Y electrode, at the first reset minimum voltage V_{nf1}+Vₑₐ; a second falling ramp generator applying a ramp waveform falling from the reset start voltage to a second reset minimum voltage V_{nf2}, to the Y electrode; and a scan pulse generator applying a scan pulse changing between a high scan voltage and a low scan voltage to the Y electrode.

Here, the sustain pulse generator includes a first switch for turning on/off a first power source with a predetermined sustain voltage; the first ground potential applying unit includes a second switch for turning on/off a second power source with a ground potential; the rising ramp generator includes a first capacitor coupled between the Y electrode and a third power source and a third switch connected between the Y electrode and the third power source; and the first falling ramp generator includes a fourth switch coupled to a fourth power source for supplying the first reset minimum voltage, a zener diode coupled between the fourth switch and the Y electrode, and a fifth switch coupled between the fourth power source and the Y electrode.

Turning the fourth switch on applies a pulse falling to the first reset minimum voltage V_{nf1}+Vₑₐ to the Y electrode. Turning the fifth switch on applies a voltage of the fourth power source to the Y electrode so that a potential difference between the Y electrode and the X electrode increases by an amount of the bias voltage −Vₑₐ.

The PDP driving apparatus according to the present invention may further include a second ground potential applying unit that applies a ground voltage to the X electrode, so that the first and second ground voltage applying units apply ground potentials to the Y electrode and the X electrode, respectively, after applying the voltage of the fourth power source.

According to an embodiment of the present invention, the scan pulse generator includes a sixth switch coupled between a fifth power source with a high scan voltage and the Y electrode and a seventh switch coupled between a sixth power source with a low scan voltage and the Y electrode. The sixth switch can be turned off and the seventh switch can be turned on when performing addressing while the sixth switch remains turned-on.

According to another embodiment of the present invention, the scan pulse generator includes a sixth switch coupled between a fifth power source with a high scan voltage and the Y electrode. The sixth switch can be turned off and the fifth switch of the first falling ramp generator can be turned on to apply a voltage of the fourth power source as a low scan voltage to the Y electrode when performing addressing while the sixth switch remains turned-on.

The second falling ramp generator includes an eighth switch coupled to a seventh power source that supplies the second reset minimum voltage V_{nf2}, thereby applying a ramp waveform falling from the reset start voltage to the second reset minimum voltage V_{nf2} to the Y electrode.

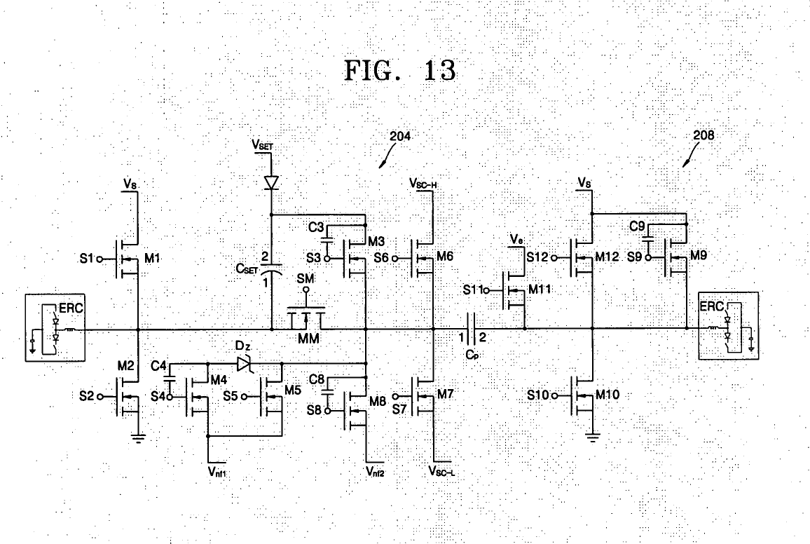

FIG. 13 is a circuit diagram of a driving apparatus for implementing the PDP driving method according to a first embodiment of the present invention. The circuit shown in FIG. 13 is provided to implement the timing diagram of FIG. 9.

Referring to FIG. 13, a capacitor C_{P} denotes panel capacitance formed between the Y electrode lines Y₁, Y₂, . . . , Yₙ and the X electrode lines X₁, X₂, . . . , Xₙ of the PDP. A first terminal of the panel capacitor C_{P} is coupled to a Y driver 204 for driving the Y electrode lines Y₁, Y₂, . . . , Yₙ, and a second terminal of the panel capacitor C_{P} is coupled to an X driver 208 for driving the X electrode lines X₁, X₂, . . . , Xₙ. The Y driver 204 and the X driver 208 may include an energy recovery circuit (ERC) for saving energy for alternately applying sustain pulses. Such an ERC is disclosed in U.S. Pat. Nos. 4,866,349, and 5,670,974.

The Y driver 204 includes first through eighth switches M1 through M8, capacitors C_{SET}, C3, C4, and C8, and a zener diode D_{Z}, and the X driver 208 includes ninth through twelfth switches M9 through M12 and a capacitor C9.

Referring to FIG. 13, a main switch MM is coupled to Y electrode lines Y₁, Y₂, . . . , Yₙ as the first terminal of the panel capacitor C_{P}. Also, in order to alternately supply a sustain pulse to the Y electrode lines Y₁, Y₂, . . . , Yₙ, a sustain pulse generator, including a first switch M1 for turning on/off the first power source with a predetermined sustain voltage V_{S}, is coupled to the Y electrode lines Y₁ through Yₙ. A first ground potential applying unit, including a second switch M2 for turning on/off the second power source with a ground potential V_{G}, is coupled to the Y electrode lines Y₁ through Yₙ in order to apply a ground voltage to the Y electrode lines Y₁ through Yₙ. Also, in order to apply a ramp-shaped pulse rising from the reset start voltage V_{S} to the reset maximum voltage V_{Set}+V_{S} to the Y electrode lines Y₁ through Yₙ, a rising ramp generator, including a first capacitor Cₛₑₜ and a third switch M3 coupled between the Y electrode lines Y₁ through Yₙ and a third power source (Vₛₑₜ), is coupled to the Y electrode lines Y1 through Yn.

Further, in order to apply a ramp-shaped pulse falling to the first reset minimum voltage V_{nf1}+Vₑₐ, as well as a bias voltage −Vₑₐ for increasing a potential difference between the Y electrodes and the X electrodes at the first reset minimum voltage V_{nf1}+Vₑₐ, to the Y electrodes Y₁ through Yₙ in the main reset period PR4, a first falling ramp generator, which includes a fourth switch M4 coupled to the fourth power source with a bottom voltage V_{nf1}, a zener diode D_{z} coupled between the fourth switch M4 and the Y electrode lines, and a fifth switch M5 coupled between the fourth power source and the Y electrode lines, is coupled to the Y electrode lines Y₁ through Yₙ.

When the fourth switch M4 is turned on, a pulse falling to the first reset minimum voltage V_{nf1}+Vₑₐ is applied to the Y electrode lines coupled to the zener diode D_{z} of the first falling ramp generator. When the fifth switch M5 is turned on, the voltage V_{nf1} of the fourth power source, providing a potential difference higher by a bias voltage −Vₑₐ than a potential difference provided by the first reset minimum voltage V_{nf1}+Vₑₐ, is applied to the Y electrode lines coupled to the zener diode D_{z} of the first falling ramp generator.

Also, a scan pulse generator which sequentially applies a scan pulse changing between a high scan voltage V_{SC-H} and a low scan voltage V_{SC-L} to the Y electrode lines Y₁ through Yₙ is coupled to the Y electrode lines Y₁ through Yₙ. In the circuit diagram of FIG. 13, the scan pulse generator includes a sixth switch M6 coupled between a fifth power source having the high scan voltage V_{SC-H} and the Y electrode lines and a seventh switch M7 coupled between a sixth power source having a low scan voltage V_{SC-L} and the Y electrode lines. The sixth switch M6 may be turned off and the seventh switch M7 may be turned on when addressing while the sixth switch M6 remains turned-on.

Also, in order to apply a ramp-shaped pulse falling from the reset start voltage V_{S} to the second reset minimum voltage V_{nf2} during a sub reset period SF5 to the Y electrode lines, a second falling ramp generator, including an eighth switch M8 coupled to a seventh power source supplying the second reset minimum voltage V_{nf2}, is coupled to the Y electrode lines Y₁ through Yₙ.

In the X driver 208, a second ground potential applying unit, including a tenth switch M10 for applying a ground potential V_{G}, is coupled to the X electrode lines as a second terminal of the panel capacitor C_{P}. A ramp switch M9 for applying a ramp-shaped erase pulse during the period t₁-t₂ of FIG. 9, a switch M11 for applying an X bias voltage Vₑ during the period t₃-t₅ of FIG. 9, and a switch M12 for applying a sustain pulse during the sustain discharge period t₅-t₆ of FIG. 9 are coupled to the X electrode lines.

After applying the voltage V_{nf1} of the fourth power source, the ground potential applying units M2 and M10 of the Y electrode lines and the X electrode lines supply ground potentials V_{G} to the Y electrode lines and the X electrode lines, respectively.

The first switch M1 and the second switch M2 of the Y driver 204 allow a sustain voltage V_{S} and a ground voltage V_{G} to be alternately applied to the Y electrode lines as the first terminal of the panel capacitor C_{P}, during a sustain-discharge period PS. The sixth switch M6 and the seventh switch M7 of the Y driver 204 allow one of a high scan voltage V_{SC-H} and a low scan voltage V_{SC-L} to be selectively applied to the Y electrode lines as the first terminal of the panel capacitor C_{P}, during an address period PA. The third, fourth, eighth, and ninth switches M3, M4, M8, and M9 pass a ramp-shaped voltage therethrough due to the influence of capacitors C3, C4, C8, and C9 coupled to the gates and sources of the switches M3, M4, M8, and M9, respectively.

Hereinafter, during the period t₁-t₆ in the fourth sub-field SF4 of FIG. 10, the operation of the circuit shown in FIG. 13 is described.

First, in order to apply an erase pulse to the X electrode lines during the time t₁-t₂ in the reset period PR4 of the fourth sub-field SF4 of FIG. 10, in the X driver 208, the tenth switch M10 is turned off and the ninth ramp switch M9 is turned on, thereby applying a rising ramp-shaped erase pulse to the X electrode lines. At this time, in the Y driver 204, the second switch M2 and the main switch MM are turned on while all other switches are turned off, so to apply a ground voltage V_{G} to the first terminal of the panel capacitor C_{P}.

Then, at time t₂, in the X driver 208, the tenth switch M10 is turned on to ground the X electrode lines. In the Y driver 204, at a start time of the rising ramp pulse, the main switch MM is maintained turned-on and the second switch M2 is turned off, and simultaneously the first switch M1 is turned on, so that the voltage V_{S} of the first power source is applied to the Y electrode lines. Then, the main switch MM is turned off, and the third switch M3 is turned on. At this time, since the voltage Vₛₑₜ of the third power source is charged in the second terminal of the first capacitor Cₛₑₜ and the first switch M1 remains turned-on, a rising ramp-shaped pulse rising from the voltage V_{S} of the first power source to the reset maximum voltage Vₛₑₜ+V_{S} is applied to the first terminal of the panel capacitor C_{P}, so that first initialization discharge occurs in corresponding discharge cells and negative charges accumulate near the Y electrodes. Here, the rising ramp-shaped pulse (between t₂ and t₃) has a predetermined slope that allows for a weak discharge.

After maintaining the reset maximum voltage Vₛₑₜ+V_{S} for a predetermined time, at the time t₃, the third switch M3 is turned off and the main switch MM is turned on with the first switch M1 remaining turned-on, so that the voltage V_{S} of the first power source is applied to the first terminal of the panel capacitor C_{P}.

Thereafter, at a start time of a falling ramp pulse, the main switch MM of the Y driver 204 is turned off, the first switch M1 is turned off, and the fourth switch M4 is turned on (the fifth switch M5 still remains turned-off), in the state where the eleventh switch M11 of the X driver 208 is turned on, thereby applying an X bias voltage Vₑ to the X electrodes. Accordingly, a falling ramp pulse falling to the first reset minimum voltage V_{nf1}+Vₑₐ is applied to the first terminal of the panel capacitor C_{P}. Due to a zener voltage Vₑₐ of the zener diode D_{Z}, a voltage higher by the zener voltage Vₑₐ than the voltage (i.e., bottom voltage V_{nf1}) of the fourth power source is applied to the first terminal of the panel capacitor C_{P}. By the falling ramp pulse, a second initialization discharge occurs in the corresponding discharge cells and some negative charges are discharged near the Y electrodes, thereby substantially uniformly distributing negative charges on all the Y electrodes. Here, the falling ramp pulse (between t₃ and t₄) has a predetermined slope to allow a weak discharge.

However, if a strong discharge is generated while applying the rising ramp pulse (between t₂ and t₃) and the falling ramp pulse (between t₃ and t₄), positive charges accumulate on the Y electrodes at the first reset minimum voltage V_{nf1}+Vₑₐ.

Accordingly, when the fifth switch M5 is turned on during the time t₃₁-t₃₂ in which the bias voltage is applied, the bottom voltage V_{nf1} of the fourth power source is applied to the Y electrodes. Therefore, as shown in FIG. 12, the bias voltage −Vₑₐ causes positive charges to accumulate on the Y electrodes Y₁ through Yₙ in addition to the positive charges already accumulated due to the strong discharge. Also, the potential difference between the Y electrodes Y₁ through Yₙ and the X electrodes X₁ through Xₙ causes additional negative charges to accumulate on the X electrodes X₁ through Xₙ. Accordingly, wall charges accumulate during the time t₃-t₃₁ when applying the falling ramp pulse, and more wall charges accumulate during the time t₃₁-t_{32.} If a voltage created by the negative wall charges accumulated on the X electrodes X₁ through Xₙ is −ΔVX, and a voltage created by the positive wall charge accumulated on the Y electrodes Y₁ through Yₙ is +ΔVY, a voltage difference ΔVX+ΔVY between the X electrodes X₁ through Xₙ and the Y electrodes Y₁ through Yₙ exceeds the discharge start voltage V_{f}. In other words, the bias voltage −Vₑₐ, which is additionally applied starting from the first reset is minimum voltage V_{nf1}+Vₑₐ to the Y electrodes Y₁ through Yₙ, is sufficient enough that the voltage difference ΔVX+ΔVY between the X electrodes X₁ through Xₙ and the Y electrodes Y₁ through Yₙ, created by wall charges additionally provided in an abnormal state in which a strong discharge is generated during a reset period, exceeds the discharge start voltage V_{f}.

Thereafter, during the ground neutralization period t₃₂-t₄, the tenth switch M10 of the X driver 208 and the second switch M2 of the Y driver 204 are turned on to ground the X electrode and the Y electrode. As such, applying the same voltage to the X electrodes X₁ through Xₙ and the Y electrodes Y₁ through Yₙ results in a zero potential difference, thereby generating the self-erase discharge and neutralizing wall charges of the X electrodes X₁ through Xₙ and the Y electrodes Y₁ through Yₙ. Consequently, when a strong discharge is generated in the reset period, positive charges accumulated on the Y electrodes Y₁ through Yₙ are erased, so that the state of wall charges accumulated on the Y electrodes Y₁ through Yₙ becomes similar to that of wall charges in normally reset discharge cells. Accordingly, in the panel driving method according to embodiments of the present invention, it is possible to prevent non-selected cells from being sustain-discharged during the sustain-discharge period even when a strong discharge is abnormally generated in a reset period.

Thereafter, during the address period PA4, the sixth switch M6 and the seventh switch M7 are selectively turned on to apply a scan pulse providing a high scan voltage V_{SC-H} and a low scan voltage V_{SC-L} to the plurality of Y electrodes. Then, during the sustain-discharge period PS4, the first switch M1 and the second switch M2 of the Y driver 204 are alternately turned on, and the tenth switch M10 and the twelfth switch M12 of the X driver 208 are alternately turned, on in the state that the main switch MM is maintained turned-on, so that sustain discharge is alternately generated between the Y electrodes and the X electrodes.

Then, during the sub reset period PR5 of the fifth sub-field SF5, a predetermined voltage (for example, a sustain voltage V_{S}) is maintained at the Y electrodes during a period t₇-t₈, and, then a falling ramp pulse (between t₈ and t₈₁) is applied to the Y electrodes.

First, during a period t₆-t₇ in the reset period PR5 of the fifth sub-field SF5 of FIG. 10, in order to apply an erase pulse to the X electrode lines, in the X driver 208, the tenth switch M10 is turned off and the ninth switch M9 is turned on. At this time, in the Y driver 204, the second switch M2 and the main switch MM are turned on while all other switches are turned off, to apply a ground voltage V_{G} to the first terminal of the panel capacitor C_{P}.

Also, at the time t₇, in the X driver 208, the tenth switch M10 is turned on, thereby grounding the X electrode lines. In the Y driver 204, the main switch MM remains turned-on and the second switch M2 is turned off at a start time of a rising ramp pulse. Simultaneously, the first switch M1 is turned on, thus applying the voltage V_{S} of the first power source to the Y electrode lines. Then, after maintaining the voltage V_{S} of the first power source for a predetermined time t₇-t₈, at a start time t₈ of a falling ramp pulse, the tenth switch M10 of the X driver 208 is turned off and the eleventh switch M11 is turned on, to apply an X bias voltage Vₑ to the X electrodes. In the state that the X bias voltage Vₑ is applied to the X electrodes, the first switch M1 of the Y driver 204 is turned off and the eighth switch M8 is turned on, so that a falling ramp pulse falling to the second reset minimum voltage V_{nf2} of the seventh power source is applied for a period t₈-t₈₁ to the first terminal of the panel capacitor C_{P}. By the falling ramp pulse, initialization discharge occurs in corresponding discharge cells and some negative charges accumulated near the Y electrodes during the previous sub-field are discharged, thus substantially uniformly distributing negative charges on all the Y electrodes. Here, the pulse (between t₈ and t₈₁) with the falling ramp waveform in the sub reset period PR5 has a predetermined slope to allow for a weak discharge. In the sub reset period PR5, since a rising ramp pulse is not applied, a relatively small amount of negative charges are accumulated on the Y electrodes, and, therefore, the probability of generating the strong discharge is low. Accordingly, during the sub-reset period PR5, it is unnecessary to apply an additional bias voltage to the Y electrodes even though the falling ramp pulse reaches the second reset minimum voltage V_{nf2}. Therefore, the fifth sub-field SF5 does not need the ground neutralization period t₃₂-t₄ described above.

As such, according to exemplary embodiments of the present invention, by selectively applying a bias pulse for self-erase discharge only during a main reset period having a higher probability of generating a strong discharge, it is possible to prevent deterioration in contrast resulting from a demagnetization discharge occurring during a sub reset period.

Thereafter, during an address period PA5, the sixth switch M6 and the seventh switch M7 are selectively turned on to provide a scan pulse having a high scan voltage V_{SC-H} and a low scan voltage V_{SC-L} to a plurality of Y electrode lines. Then, during a sustain discharge period PS5, the first switch M1 and the second switch M2 of the Y driver 204 are alternately turned on, and the tenth switch M10 and the twelfth switch M12 of the X driver 208 are alternately turned on, so that sustain-discharge is alternately generated between the X electrodes and the Y electrodes.

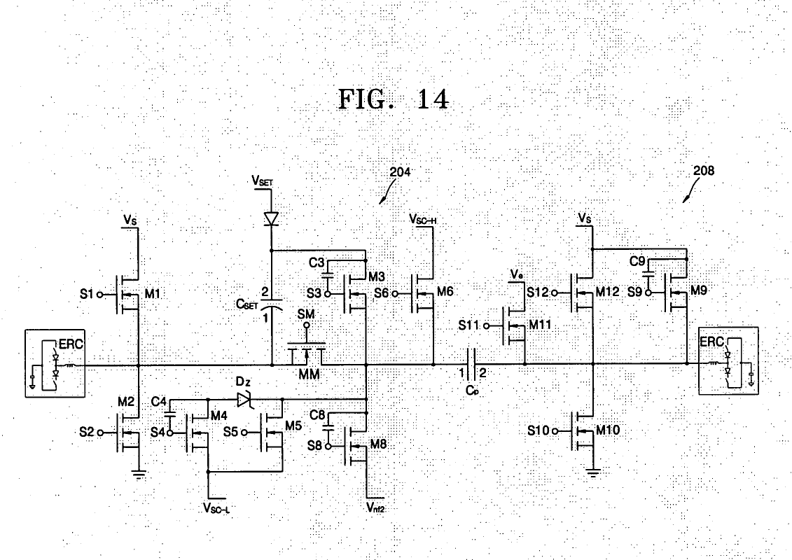

FIG. 14 is a circuit diagram of a driving apparatus for implementing a PDP driving method according to a second embodiment of the present invention. The circuit shown in FIG. 14 may be used to implement the driving signals shown in the timing diagram of FIG. 11.

The circuit of FIG. 14 differs from the circuit of FIG. 13 in that the seventh switch M7 is omitted and the voltage of the fourth power source is equal to the low scan voltage V_{SC-L}. According to the driving apparatus including the circuit of FIG. 14, a bottom voltage, which is applied during a charge accumulation period t₃₁-t₃₂ of the reset period PR4, is equal to the low scan voltage V_{SC-L}.

In the driving apparatus including the circuit of FIG. 14, a scan pulse generator includes a fifth power source with a high scan voltage V_{SC-H} and a sixth switch M6 coupled between the fifth power source and Y electrode lines. The sixth switch M6 is turned off and a fifth switch M5 of a first falling ramp generator is turned on when addressing while the sixth switch remains turned-on, so that a voltage of a fourth power source is applied as a low scan voltage V_{SC-L}, thereby selecting the first electrode of the panel capacitor Cp.

By using the driving apparatus including the circuit of FIG. 14, since a driving circuit for supplying a bias voltage −Vₑₐ to be applied to the Y electrodes Y₁ through Yₙ can be shared with a driving circuit supplying the low scan voltage V_{SC-L}, the manufacturing cost of a PDP's driving apparatus may be reduced.

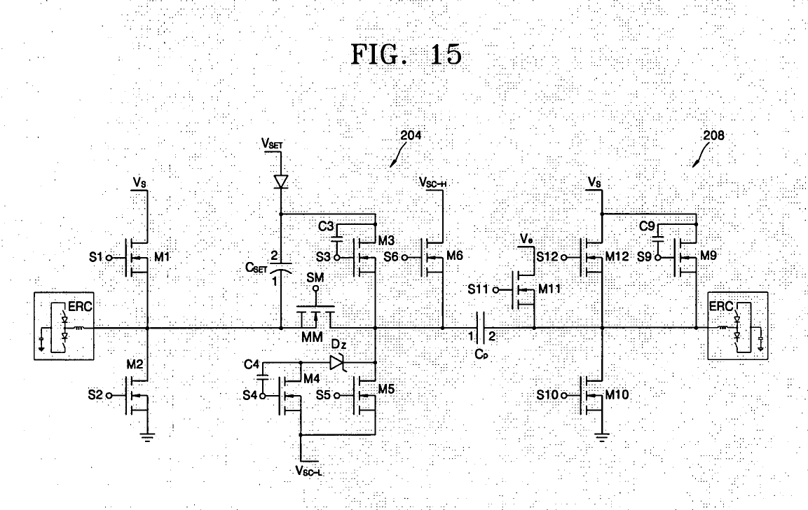

FIG. 15 is a circuit diagram of a driving apparatus for implementing a PDP driving method according to a third embodiment of the present invention, wherein a potential of the second reset minimum voltage V_{nf2} equals that of the first reset minimum voltage V_{nf1}+Vₑₐ.

The circuit of FIG. 15 differs from that of FIG. 13 in that the seventh switch M7 is omitted, a voltage of the fourth power source equals the low scan voltage V_{SC-L}, and the seventh power source and the eighth switch M8 are omitted. According to the driving apparatus including the circuit of FIG. 15, a bottom voltage applied during a charge accumulating period t₃₁-t₃₂ of a main reset period PR4 equals the low scan voltage V_{SC-L}. Also, a potential at which a falling ramp pulse of a sub reset period PR5 reaches the second reset minimum voltage V_{nf2} equals that of the first reset minimum voltage V_{nf1}+Vₑₐ.

In the driving apparatus including the circuit of FIG. 15, a second falling ramp generator, which applies a ramp waveform falling from a reset start voltage V_{S} to the second reset minimum voltage V_{nf2} to the Y electrodes, is similar to the first falling ramp generator. In this case, a potential difference ΔV_{Z} between the second reset minimum voltage V_{nf2} of the sub reset period PR5 and the bottom voltage V_{nf1} or V_{SC-L} of the main reset period PR4 of the fourth sub-field is equal to the magnitude Vₑₐ of the bias voltage. Therefore, the second falling ramp generator can share the fifth switch M5 of the first falling ramp generator with the first falling ramp generator. Accordingly, in the driving apparatus including the circuit of FIG. 15, since a driving circuit for supplying a bias voltage −Vₑₐ to be applied to the Y electrodes Y₁ through Yₙ can be shared with a driving circuit of the second falling ramp generator for supplying a falling ramp pulse in a sub reset period PR5, the manufacturing cost of a PDP's driving apparatus may be reduced.

Additionally, in the driving apparatus including the circuit of FIG. 15, the scan pulse generator includes a sixth switch M6 coupled between a fifth power source with a high scan voltage V_{SC-H} and Y electrode lines, wherein the sixth switch M6 is turned off and the fifth switch M5 of the first falling ramp generator is turned on when addressing while the sixth switch is maintained turned-on. Accordingly, the voltage of the fourth power source may be applied as the low scan voltage V_{SC-L}. Consequently, according to the driving apparatus including the circuit of FIG. 15, since a driving circuit for supplying the bias voltage −Vₑₐ to be applied to the Y electrodes Y₁ through Yₙ can be shared with a driving circuit for supplying the low scan voltage V_{SC-L}, the manufacturing cost of a PDP driving apparatus may be reduced.

As described above, according to embodiments of the PDP driving method and apparatus of the present invention, the following effects may be achieved.

First, since wall charges are in a normal state even though initialization of some discharge cells fails, it is possible to improve reliability in a reset operation for initializing the state of wall charges of the PDP's discharge cells.

Second, by applying a voltage waveform for setting wall charges in a normal state against an unintentionally strong discharge during reset periods for initializing discharge cells, it is possible to improve reliability in resetting, reliability in gray-scale display, and contrast of displayed pictures.

Third, by selectively applying a bias pulse for a self-erase discharge only during main reset periods having a higher probability of generating a strong discharge, it is possible to prevent deterioration in contrast resulting from a self-erase discharge occurring during sub reset periods.

Fourth, since a driving circuit for supplying a bias voltage to be applied to Y electrodes can be shared with a driving circuit for supplying a low scan voltage, it is possible to reduce the cost of manufacturing a PDP driving apparatus. Also, since a driving circuit for supplying a bias voltage to be applied to Y electrodes can be shared with a driving circuit of a second falling ramp generator for supplying a falling ramp pulse during sub reset periods, it is possible to further reduce the cost of manufacturing a PDP.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A driving method of a plasma display panel, the plasma display panel including an address electrode and a first electrode and a second electrode arranged substantially orthogonal to the address electrode, in which gray-scale levels are represented using a reset period, an address period, and a sustain-discharge period, comprising:
in a reset period of a first sub-field, applying a rising ramp pulse and a falling ramp pulse to the first electrode, thus initializing wall charges of a discharge cell, wherein a self-erase discharge is generated if a strong discharge occurs between the first electrode and the second electrode; and
in a reset period of a second sub-field, applying a falling ramp pulse to the first electrode.

2. The method of claim 1, wherein, in the reset period of the first sub-field, a rising ramp pulse rising from a reset start voltage to a reset maximum voltage is applied to the first electrode, and, then, a falling ramp pulse falling to a first reset minimum voltage is applied to the first electrode, and
a bias voltage for increasing a potential difference between the first electrode and the second electrode is applied to the first electrode at the first reset minimum voltage.

3. The method of claim 2, wherein, in the reset period of the first sub-field, an amplitude of the bias voltage is set so that a difference between a voltage of the first electrode and a voltage of the second electrode exceeds a discharge start voltage, when the strong discharge occurs while the falling ramp pulse is applied.

4. The method of claim 3, wherein the amplitude of the bias voltage equals a difference between a low scan voltage and the first reset minimum voltage, and
wherein the low scan voltage is applied to the first electrode in the address period to select the first electrode.

5. The method of claim 3, further comprising applying a neutral voltage to the first electrode and the second electrode after applying the bias voltage to the first electrode.

6. The method of claim 5, wherein the neutral voltage is a ground voltage.

7. The method of claim 6, wherein, when the neutral voltage is applied, the self-erase discharge is generated between positive wall charges accumulated on the first electrode and negative wall charges accumulated on the second electrode.

8. The method of claim 1, further comprising:
in the address period, applying address data to the address electrode when a scan pulse is applied to the first electrode to select the discharge cell; and
in the sustain-discharge period, alternately applying a sustain pulse with a sustain voltage to the first electrode and the second electrode, thus generating sustain-discharge in the selected discharge cell,
wherein the sustain pulse has an amplitude not allowing sustain-discharge when the self-erase discharge is generated in the reset period of the first sub-field.

9. The method of claim 2, further comprising:
in the address period, applying address data to the address electrode when a scan pulse is applied to the first electrode to select the discharge cell; and
in the sustain-discharge period, alternately applying a sustain pulse with a sustain voltage to the first electrode and the second electrode, thus generating sustain-discharge in the selected discharge cell,
wherein the bias voltage applied to the first electrode is higher than a voltage at which no address discharge occurs in the address period by causing positive wall charges accumulated by the bias voltage to erase negative wall charges accumulated on the first electrode without the strong discharge.

10. The method of claim 1, wherein, during the reset period of the second sub-field, if negative wall charges are accumulated on the first electrode due to sustain-discharge generated in a previous sub-field, a falling ramp pulse falling to a second reset minimum voltage is applied to the first electrode.

11. A computer-readable medium having embodied thereon a computer program for executing the method of claim 1.

12. An apparatus for driving a plasma display panel, the plasma display panel including a first electrode and a second electrode, comprising:
a sustain pulse generator alternately supplying a sustain pulse to the first electrode and the second electrode;
a first ground potential applying unit applying a ground potential to the first electrode;
a rising ramp generator applying a ramp waveform rising from a reset start voltage to a reset maximum voltage to the first electrode;
a first falling ramp generator applying a ramp waveform falling to a first reset minimum voltage to the first electrode and applying a bias voltage for increasing a potential difference between the first electrode and the second electrode to the first electrode at the first reset minimum voltage;
a second falling ramp generator applying a ramp waveform falling from the reset start voltage to a second reset minimum voltage to the first electrode; and
a scan pulse generator applying a scan pulse changing between a high scan voltage and a low scan voltage to the first electrode.

13. The apparatus of claim 12, wherein:
the sustain pulse generator comprises a first switch coupled to a first power source with a predetermined sustain voltage, and the first ground potential applying unit comprises a second switch coupled to a second power source with a ground potential;
the rising ramp generator comprises a first capacitor coupled between the first electrode and a third power source, and a third switch coupled between the first electrode and the third power source; and
the first falling ramp generator comprises a fourth switch coupled to a fourth power source supplying the first reset minimum voltage, a zener diode coupled between the fourth switch and the first electrode, and a fifth switch coupled between the fourth power source and the first electrode.

14. The apparatus of claim 13, wherein, if the fourth switch is turned on, a pulse falling to the first reset minimum voltage is applied to the first electrode, and, if the fifth switch is turned on, a voltage of the fourth power source is applied to the first electrode and a potential difference between the first electrode and the second electrode increases by an amount of the bias voltage.

15. The apparatus of claim 14, further comprising a second ground potential applying unit applying a ground potential to the second electrode, wherein,
after the voltage of the fourth power source is applied to the first electrode, the first ground potential applying unit and the second ground potential applying unit apply the ground potential to the first electrode and the second electrode, respectively.

16. The apparatus of claim 13, wherein the scan pulse generator comprises a sixth switch coupled between a fifth power source with the high scan voltage and the first electrode and a seventh switch coupled between a sixth power source with the low scan voltage and the first electrode, wherein,
the sixth switch is turned off and the seventh switch is turned on to select the first electrode.

17. The apparatus of claim 13, wherein the scan pulse generator comprises a sixth switch coupled between a fifth power source with the high scan voltage and the first electrode, and
the sixth switch is turned off and the fifth switch of the first falling ramp generator is turned on to select the first electrode with the voltage of the fourth power source as the low scan voltage.

18. The apparatus of claim 13, wherein the second falling ramp generator comprises an eighth switch coupled to a seventh power source supplying the second reset minimum voltage.

19. The apparatus of claim 13, wherein the second falling ramp generator shares the fifth switch of the first falling ramp generator with the first falling ramp generator.

20. A driving method of a plasma display panel, the plasma display panel including an address electrode and a first electrode and a second electrode arranged substantially orthogonal to the address electrode, in which gray-scale levels are represented using a reset period, an address period, and a sustain-discharge period, comprising:
in a reset period of a first sub-field, applying a voltage rising from a first level to a second level and falling from a third level to a fourth level to the first electrode, thus initializing wall charges of a discharge cell, wherein a self-erase discharge is generated if a strong discharge occurs between the first electrode and the second electrode; and
in a reset period of a second sub-field, applying a voltage falling from a ninth level to a tenth level to the first electrode.

21. The method of claim 20, wherein, in the reset period of the first sub-field, the voltage rising from the first level to the second level is applied to the first electrode and then the voltage falling from the third level to the fourth level is applied to the first electrode, and
a bias voltage for increasing a potential difference between the first electrode and the second electrode is applied to the first electrode at the fourth level, thereby setting a voltage at the first electrode to a fifth level.

22. The method of claim 21, wherein, in the reset period of the first sub-field, an amplitude of the bias voltage is set so that a difference between a voltage of the first electrode and a voltage of the second electrode exceeds a discharge start voltage, when the strong discharge occurs while the voltage falling from the third level to the fourth level is applied to the first electrode.

23. The method of claim 22, wherein the amplitude of the bias voltage equals a difference between an eighth level and the fourth level, and
wherein a voltage of the eighth level is applied to the first electrode in the address period to select the first electrode.

24. The method of claim 22, further comprising, in the reset period of the first sub-field, applying a voltage of a sixth level to the first electrode and the second electrode after applying the bias voltage to the first electrode.

25. The method of claim 24, wherein the sixth level is a ground voltage.

26. The method of claim 25, wherein, when the sixth level is applied to the first electrode and the second electrode, the self-erase discharge is generated between positive wall charges accumulated on the first electrode and negative wall charges accumulated on the second electrode.

27. The method of claim 20, further comprising:
in the address period, applying address data to the address electrode when a scan pulse is applied to the first electrode to select the discharge cell; and
in the sustain-discharge period, alternately applying a sustain pulse with a sustain voltage to the first electrode and the second electrode, thus generating sustain-discharge in the selected discharge cell,
wherein the sustain pulse has an amplitude not allowing sustain-discharge when the self-erase discharge is generated in the reset period of the first sub-field.

28. The method of claim 21, further comprising:
in the address period, applying address data to the address electrode when a scan pulse is applied to the first electrode to select the discharge cell; and
in the sustain-discharge period, alternately applying a sustain pulse with a sustain voltage to the first electrode and the second electrode, thus generating sustain-discharge in the selected discharge cell,
wherein the bias voltage applied to the first electrode is higher than a voltage at which no address discharge occurs in the address period by causing positive wall charges accumulated by the bias voltage to erase negative wall charges accumulated on the first electrode without the strong discharge.

29. The method of claim 24, further comprising, in the reset period of the first sub-field, maintaining a voltage of the second electrode at a seventh level while applying the voltage falling from the third level to the fourth level to the first electrode and while maintaining a voltage at the first electrode at the fifth level.

30. The method of claim 24, wherein the fifth level has substantially the same magnitude as the eighth level.

31. The method of claim 24, wherein the fourth level has substantially the same magnitude as the tenth level.

32. The method of claim 21, wherein in the reset period of the first sub-field, the voltage rising from the first level to the second level is a rising ramp waveform, and the voltage falling from the third level to the fourth level is a falling ramp waveform.
